(19) United States
(12) Patent Application Publication
(10) Pub. No.: US 2021/0036356 A1
(43) Pub. Date: Feb. 4, 2021

(54) Electrode Sheet Rolling Apparatus, Guide Roll System Used Therein, and Method of Winding Electrode Sheet Using the Same

(71) Applicant: LG Chem, Ltd., Seoul (KR)

(72) Inventors: Yong Hee Kang, Daejeon (KR); Young Jun Lee, Daejeon (KR); Sang Min Kim, Daejeon (KR)

(73) Assignee: LG Chem, Ltd., Seoul (KR)

(21) Appl. No.: 16/614,230

(22) PCT Filed: Nov. 22, 2018
(86) PCT No.: PCT/KR2018/014455

§ 371 Date: Nov. 15, 2019

(30) Foreign Application Priority Data
Nov. 24, 2017 (KR) 10-2017-0158920

(51) Int. Cl. H01M 10/04; H01M 4/04; B21D 28/02; B65H 23/26; B21B 3/00

(52) U.S. Cl. CPC H01M 10/0431; H01M 4/0435; B21D 28/02; B21B 2003/001; B21B 3/00; H01M 4/0471; B65H 2515/40; B65H 23/26

(57) ABSTRACT

Provided is an electrode sheet rolling apparatus including: a process unit for performing a rolling or notching process of an electrode sheet, a rewinding unit for winding the electrode sheet finished with the process in the process unit, and a guide roll system which is disposed between the process unit and the rewinding unit and guides the electrode sheet from the process unit to the rewinding unit, wherein the guide roll system includes a plurality of rolls arranged in parallel with each other, and temperatures of the plurality of rolls are set sequentially high along a transfer direction of the electrode sheet.

### CROSS-REFERENCE TO RELATED APPLICATION(S)

This application claims priority to and the benefit of Korean Patent Application No. 10-2017-0158920 filed in the Korean Intellectual Property Office on Nov. 24, 2017, the entire contents of which are incorporated herein by reference.

### TECHNICAL FIELD

The present invention relates to an electrode sheet rolling apparatus, a guide roll system used therein, and a method of winding an electrode sheet using the same, and particularly, to an apparatus for rolling an electrode sheet used in a rechargeable battery, a guide roll system used therein, and a method of winding an electrode sheet using the same.

### BACKGROUND ART

The use of a rechargeable battery which may be semi-permanently used by recharging is gradually extended from a power supply of a portable electronic device, of course, to a power source of an automobile.

The rechargeable battery is manufactured by applying an active material on a surface of a current collector to form a positive electrode and a negative electrode and interposing a separator between the positive and negative electrodes to form an electrode assembly, which is then mounted inside of a cylindrical or square-shaped metal can or a pouch-shaped case of an aluminum laminate sheet. Here, an aluminum electrode sheet for forming the electrode of the rechargeable battery is provided in a roll form in which the aluminum electrode sheet is wound in a scroll form, and in the manufacturing process, the wound electrode sheet roll is unwound, subjected to operations such as notching and stretching, wound again to be in a roll form, and then subjected to the next process.

However, for implementing a high-capacity and high-density battery cell, the thickness of an aluminum foil used as an electrode sheet is made small and the rolling density thereof is set high, but which causes deformation and camber of the foil as shown in FIG. 6, during a roll press process for manufacturing an electrode. This leads to disconnection during a notching process and a deteriorated yield due to a bad lamination position. The deformation and camber of the foil occur, since the foil is partially coated, and due to an elongation difference between a coated portion and an uncoated portion, the foil is bent toward the uncoated portion having a high elongation or the uncoated portion is torn, as shown in FIG. 7.

### DISCLOSURE

### Technical Problem

The present invention has been made in an effort to provide an electrode sheet rolling apparatus, a guide roll system used therein, and a method of winding an electrode sheet using the same having advantages of an improved yield by minimized deformation and camber occurrence prevention of a sheet for an electrode during a rechargeable battery cell manufacturing process.

### Technical Solution

An exemplary embodiment of the present invention provides a guide roll system for transferring an electrode sheet including: a plurality of rolls disposed in parallel with each other and roll heating devices independently to heat at least two of the plurality of rolls, wherein a position of at least one of the plurality rolls is movable relative to the other one(s).

The plurality of rolls includes a first roll, a second roll, and a third roll in the order in which the rolls are disposed, wherein the temperatures of the first roll, the second roll, and the third roll may be set sequentially high, and a fourth roll and a fifth roll which are sequentially disposed next to the third roll are further included, wherein a temperature of the fourth roll is higher than a temperature of the third roll and a temperature of the fifth roll is identical to or higher than the temperature of the fourth roll.

The electrode sheet may be transferred through lower surfaces of the first roll, the third roll, and the fifth roll and upper surfaces of the second roll and the fourth roll, the positions of the first roll, the third roll, and the fifth roll may be fixed, and the second roll and the fourth roll may be installed to be moved up and down.

The first roll may be set at 70° C. to 90° C., the second roll may be set at 105° C. to 125° C., the third roll may be set at 120° C. to 140° C. , and the fourth roll and fifth roll may be set at 140° C. to 160° C. The first roll is set at 80° C., the second roll is set at 115° C., the third roll set at 130° C., and the fourth roll and fifth roll are set at 150° C., and a moving speed of the electrode sheet is 40 m/min and a tension applied to the electrode sheet may be 80 N.

The plurality of rolls includes a plurality of first type rolls and a plurality of second type rolls having a diameter smaller than a diameter of the first type roll, the roll heating devices may independently heat the plurality of first type rolls, the positions of the plurality of first type rolls are fixed, and the second type roll may be installed so that the position of the second type roll is moved in an up and down direction.

Temperatures of the plurality of first type rolls may be set sequentially high in the order in which the rolls are disposed or the same.

The electrode sheet rolling apparatus according to an exemplary embodiment of the present invention includes a process unit for performing a process of rolling or notching an electrode sheet, a rewinding unit for winding the electrode sheet finished with the process in the process unit, and a guide roll system which is disposed between the process unit and the rewinding unit and guides the electrode sheet from the process unit to the rewinding unit, wherein the guide roll system includes a plurality of rolls arranged in parallel with each other and the plurality of rolls may have different temperatures from each other.

The plurality of rolls includes a first roll, a second roll, and a third roll in the order in which the rolls are disposed, temperatures of the first roll, the second roll, and the third roll may be set sequentially high, a fourth roll and a fifth roll which are sequentially disposed next to the third roll are further included, a temperature of the fourth roll is higher than a temperature of the third roll, and a temperature of the fifth roll may be identical to or higher than a temperature of the fourth roll.

The electrode sheet is transferred through lower surfaces of the first roll, the third roll, and the fifth roll and upper surfaces of the second roll and the fourth roll, positions of the first roll, the third roll, and the fifth roll are fixed, the second roll and the fourth roll may be installed to be moved up and down, and the first roll may be set at 70° C. to 90° C., the second roll may be set at 105° C. to 125° C., the third roll may be set at 120° C. to 140° C., and the fourth roll and fifth roll may be set at 140° C. to 160° C.

The plurality of rolls includes a plurality of first type rolls and a plurality of second type rolls having a diameter smaller than a diameter of the first type roll, the roll heating devices may independently heat the plurality of first type rolls, positions of the plurality of first type rolls are fixed, and the second type roll may be installed so that the position of the second type roll is moved in an up and down direction.

Temperatures of the plurality of first type rolls may be set sequentially high in the order in which the rolls are disposed or the same.

The method of winding an electrode sheet according to an exemplary embodiment of the present invention by subjecting the electrode sheet to a predetermined process and passing the electrode sheet through a guide roll system including a plurality of rolls to wind the electrode sheet may include setting a transferring speed of the electrode sheet, setting temperatures of the plurality of rolls sequentially high along a movement direction of the electrode sheet, and moving positions of at least a part of the plurality of rolls to adjust tension applied to the electrode sheet.

The guide roll system includes the first to fifth rolls which are sequentially disposed in parallel with each other, the first roll is set at 70° C. to 90° C., the second roll is set at 105° C. to 125° C., the third roll is set at 120° C. to 140° C., and the fourth roll and fifth roll are set at 140° C. to 160° C., a moving speed of the electrode sheet is set at 20 m/min to 60 m/min, and a tension applied to the electrode sheet may be 80 N to 120 N.

### Advantageous Effects

Use of the electrode sheet rolling apparatus and the roll system used therein according to an exemplary embodiment of the present invention allows decreased occurrence of camber and prevention of folding or breaking of a part of the electrode sheet during the process.

### DESCRIPTION OF THE DRAWINGS

FIG. 1 is a schematic diagram of an electrode sheet rolling apparatus according to an exemplary embodiment of the present invention.

FIG. 2 is a side view of a guide roll system used in the electrode sheet rolling apparatus according to an exemplary embodiment of the present invention.

FIG. 3 is a graph showing a degree of decreased camber occurrence when a notching pattern is formed in a center part using the electrode sheet rolling apparatus according to an exemplary embodiment of the present invention.

FIG. 4 is a graph showing a degree of decreased camber occurrence when a notching pattern is formed in a side part using the electrode sheet rolling apparatus according to an exemplary embodiment of the present invention.

FIG. 5 is a side view of a guide roll system used in an electrode sheet rolling apparatus according to another exemplary embodiment of the present invention.

FIG. 6 is a photograph showing a camber defect produced in a rolling process according to the conventional art.

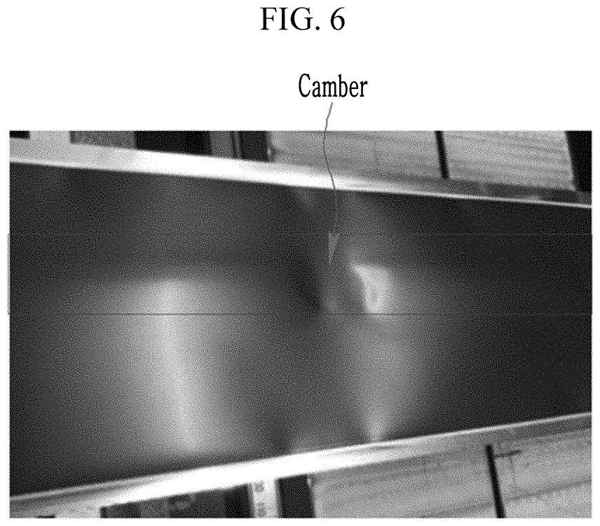

FIG. 7 is a drawing showing a part of the electrode sheet for describing a cause of camber produced in the rolling process.

### MODE FOR INVENTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

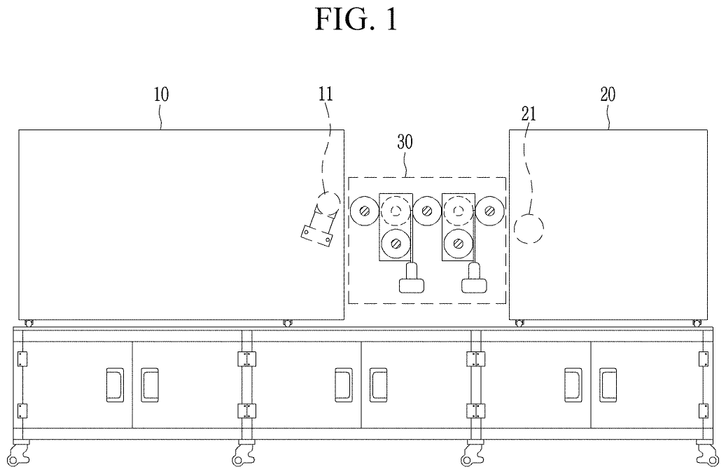

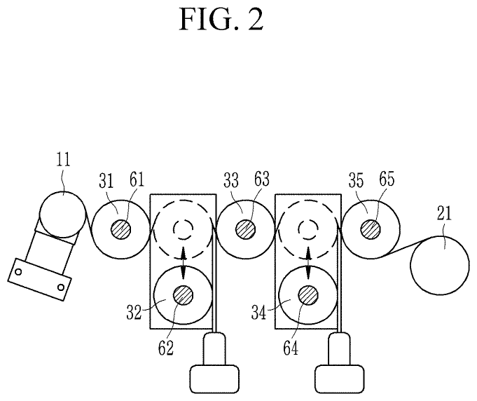

FIG. 1 is a schematic diagram of an electrode sheet rolling apparatus according to an exemplary embodiment of the present invention; and FIG. 2 is a side view of a guide roll system used in the electrode sheet rolling apparatus according to an exemplary embodiment of the present invention.

Referring to FIG. 1, an electrode sheet rolling apparatus according to an exemplary embodiment of the present invention includes a process unit 10, a guide roll system 30, and a rewinding unit 20. The process unit 10 is a part in which the wound electrode sheet is unwound to be subjected to a process such as rolling or notching, the rewinding unit 20 is a part of rewinding the electrode sheet finished with the process, and the guide roll system 30 is a part which is disposed between the process unit 10 and the rewinding unit 20 and applies appropriate tension and heat to the electrode sheet for being rewound after being finished with the process to prevent occurrence of defects such as camber or breaking.

Referring to FIG. 2, the guide roll system 30 of the electrode sheet rolling apparatus according to an exemplary embodiment of the present invention will be described in more detail.

The guide roll system 30 according to an exemplary embodiment of the present invention includes five cylindrical rolls 31, 32, 33, 34, and 35 which are disposed in parallel with each other. Among the rolls 31, 32, 33, 34, and 35, the positions of the first, third and fifth rolls 31, 33, and 35 are fixed, and the second and fourth rolls 32 and 34 may be installed to be moved up and down. The second and fourth rolls 32 and 34 are independently movable up and down and may apply appropriate tension to the electrode sheet. The electrode sheet comes out through an upper surface of a draw out roll 11 of the process unit 10 and enters a leading roll 21 of the rewinding unit 20 through a lower surface of the first roll 31, an upper surface of the second roll 32, a lower surface of the third roll 33, an upper surface of the fourth roll 34, and a lower surface of the fifth roll 35 of the guide roll system 30. Here, when the electrode sheet is too loose, the second roll 32 or the fourth roll 34 is moved up, thereby adjusting tension applied to the electrode sheet. Here, the first, third and fifth rolls 31, 33, and 35 are not necessarily fixed, and may be installed to be independently moved, and a movement direction of the second and fourth rolls 32 and 34 may be left and right as well as up and down. However, for simpler equipment, the first, third and fifth rolls 31, 33, and 35 may be fixed and only the second and fourth rolls 32 and 34 may be installed to be moved up and down. The number of rolls is not limited to five and may be adjusted as required from two or more.

Since the five rolls 31, 32, 33, 34, and 35 of the guide roll system 30 are provided with heating devices 61, 62, 63, 64, and 65 capable of independent heating, the five rolls 31, 32, 33, 34, and 35 may be controlled to have different temperature from each other. The heating devices 61, 62, 63, 64, and 65 may be a heat transfer device embedded in the rolls 31, 32, 33, 34, and 35 themselves, or the like, but are not limited thereto, may be a device which generates heat from the outside of the rolls 31, 32, 33, 34, and 35 and heats the rolls 31, 32, 33, 34, and 35 by conduction or radiation, or may be a heating device by magnetic induction. These five rolls 31, 32, 33, 34, and 35 are heated at an appropriate temperature, thereby capable of heat-treating the electrode sheet which is moved through the rolls. The temperature of the roll is set gradually higher from the first roll 31 to the fifth roll 35, thereby preventing occurrence of deformation such as wrinkles or folding in the electrode sheet due to heat shrinkage by a rapid temperature rise. It is advantageous to set the temperature of the first roll 31 at 100° C. or less for preventing deformation of the electrode sheet due to heat shrinkage. As an example of temperature setting of the first to fifth rolls 31, 32, 33, 34, and 35, the first roll 31 may be set at 80° C., the second roll 32 may be set at 115° C., the third roll 33 may be set at 130° C., the fourth roll 34 may be set at 150° C., and the fifth roll 35 may be set at 150° C. As such, the temperatures of the rolls are sequentially raised from the first roll 31 to the fourth roll 34, whereby the electrode sheet passing therethrough may be gradually heated, and the fourth roll 34 and the fifth roll 35 are brought to have the same final heat treatment temperature, thereby securing a required heat treatment time. For a sequential temperature rise as such, the first roll 31 may be set at 70° C. to 90° C., the second roll 32 may be set at 105° C. to 125° C., the third roll 33 may be set at 120° C. to 140° C., and the fourth and fifth rolls 34 and 35 may be set at 140° C. to 160° C. A higher final heat treatment temperature is advantageous for prevention of camber occurrence; however, when the electrode sheet is heated to an excessively high temperature, there is a concern that the strength thereof becomes weak or the coating is damaged, and thus, around 150° C. is appropriate.

A moving speed of the electrode sheet is also related to prevention of camber occurrence and productivity. A slower moving speed of the electrode sheet is effective for prevention of camber occurrence; however, a slower speed lowers productivity, and thus, considering both, an appropriate speed should be applied, and here, 20 m/min to 60 m/min is appropriate, and 40 m/min is particularly suitable.

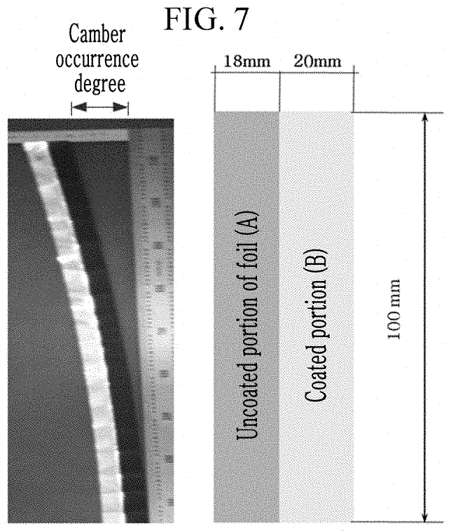

Tension applied to the electrode sheet is also related to prevention of camber occurrence; however, there is no constant directionality and an appropriate value is varied depending on a heat treatment temperature or a moving speed. The following Table 1 shows a camber occurrence degree which was measured by varying the moving speed of the electrode sheet, the tension applied to the electrode sheet, and the final heat treatment temperature. The camber occurrence degree is represented by a widened distance of the electrode sheet having a length of 1 m from a plane due to camber. FIG. 7 shows a scene of measuring the camber occurrence degree. However, FIG. 7 shows only the part in which the camber occurs of the electrode sheet of 1 m.

TABLE 1

| Run | Speed | Tension | Temp | Camber |
|---|---|---|---|---|
| order | (m/min) | (N) | (° C.) | (mm) |
| 1 | 20 | 120 | 150 | 18 |
| 2 | 20 | 80 | 100 | 22 |
| 3 | 20 | 80 | 150 | 17 |
| 4 | 60 | 80 | 100 | 23 |
| 5 | 60 | 120 | 150 | 21 |
| 6 | 60 | 80 | 100 | 23 |
| 7 | 60 | 120 | 100 | 25 |
| 8 | 20 | 120 | 100 | 23 |
| 9 | 60 | 120 | 150 | 18 |
| 10 | 20 | 80 | 150 | 14 |
| 11 | 60 | 80 | 150 | 20 |
| 12 | 60 | 80 | 150 | 17 |
| 13 | 20 | 120 | 150 | 19 |
| 14 | 60 | 120 | 100 | 22 |
| 15 | 20 | 120 | 100 | 23 |
| 16 | 20 | 80 | 100 | 24 |

According to Table 1, it is shown that camber occurs the least at a moving speed of 20 m/min, a tension of 80 N, and a final heat treatment temperature of 150° C., and considering productivity and a process balance, a moving speed of 40 m/min, a tension of 80 N, and a final heat treatment temperature of 150° C. may be more suitable.

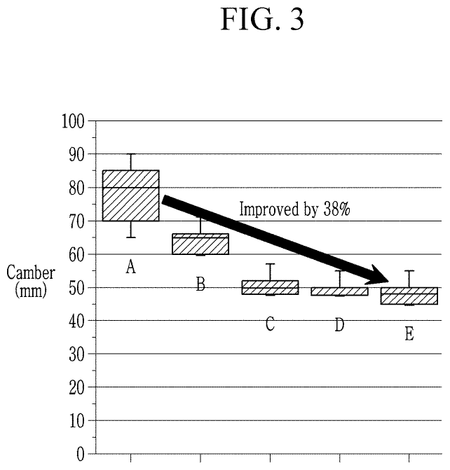

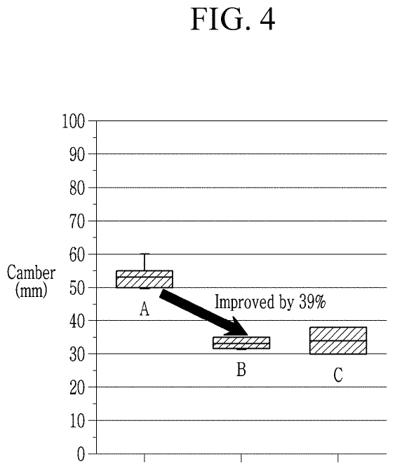

FIG. 3 is a graph showing a degree of decreased camber occurrence when a notching pattern is formed in a center part using the electrode sheet rolling apparatus according to an exemplary embodiment of the present invention; and FIG. 4 is a graph showing a degree of decreased camber occurrence when a notching pattern is formed in a side part using the electrode sheet rolling apparatus according to an exemplary embodiment of the present invention.

In FIG. 3, leftmost pattern A is the case where when in the process unit 10, a notching pattern was formed in the center part of the electrode sheet and then the electrode sheet was rewound, the guide roll system 30 was not used to perform heat treatment, pattern B is the case where the moving speed of the electrode sheet was 80 m/min, the final heat treatment temperature was 100° C., and the tension is 140 N, patterns C and D are the case where the moving speed of the electrode sheet was 80 m/min, the final heat treatment temperature was 130° C., and the tension was 110 N, and pattern E is the case where the moving speed of the electrode sheet was 80 m/min, the final heat treatment temperature was 130° C., and the tension was 130 N. Degrees of camber occurrence in each case of A to E were represented as 79 mm, 66 mm, 51 mm, 50 mm, and 49 mm in order. That is, it is recognized that when the electrode sheet having a notching pattern formed in the center part is heat-treated and rewound with appropriate tension and temperature using the electrode sheet rolling apparatus according to an exemplary embodiment of the present invention, camber is greatly decreased.

In FIG. 4, leftmost pattern A is the case where when in the process unit 10, a notching pattern was formed in one side part of the electrode sheet and then the electrode sheet was rewound, the guide roll system 30 was not used to perform heat treatment, and patterns B and C are the case where the moving speed of the electrode sheet was 80 m/min, the final heat treatment temperature was 130° C., and the tension was 130 N. Degrees of camber occurrence in each case of A, B, and C were represented as 53 mm, 33 mm, and 32 mm in order. That is, it is recognized that when the electrode sheet having a notching pattern formed in the side part is heat-treated and rewound with appropriate tension and temperature using the electrode sheet rolling apparatus according to an exemplary embodiment of the present invention also, camber is greatly decreased.

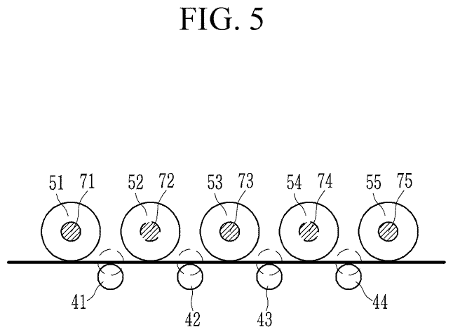

FIG. 5 is a side view of a guide roll system used in an electrode sheet rolling apparatus according to another exemplary embodiment of the present invention.

The guide roll system according to another exemplary embodiment of the present invention includes five large rolls 51, 52, 53, 54, and 55, and four small rolls 41, 42, 43, and 44. The positions of the five large rolls 51, 52, 53, 54, and 55 are fixed, and the four small rolls 41, 42, 43, and 44 may be installed so that the positions of the rolls are movable up and down. Otherwise, the second and fourth large rolls 52 and 54 may be also installed so that the positions of the rolls are movable up and down, like the four small rolls 41, 42, 43, and 44, and in addition to that, rolls of which the positions are movable may be determined by various combinations. The electrode sheet may be formed to pass between the five large rolls 51, 52, 53, 54, and 55 and the four small rolls 41, 42, 43, and 44.

Since the five large rolls 51, 52, 53, 54, and 55 are provided with heating devices 71, 72, 73, 74, and 75 capable of independent heating, the five large rolls 51, 52, 53, 54, and 55 may be controlled to have different temperature from each other. Though the four small rolls 41, 42, 43, and 44 may be also provided with heating devices, only the five large rolls 51, 52, 53, 54, and 55 are provided with heating means and the four small rolls 41, 42, 43, and 44 may be provided with only position moving means for tension adjustment, considering efficiency of a device configuration.

Like the guide roll system of FIG. 2, the temperature of the roll is set gradually higher from the first large roll 51 to the fifth large roll 55, thereby preventing occurrence of deformation such as wrinkles or folding in the electrode sheet due to heat shrinkage by a rapid temperature rise. It is advantageous to set the temperature of the first large roll 51 at 100° C. or less for preventing deformation of the electrode sheet due to heat shrinkage. The temperatures of the rolls are sequentially raised from the first large roll 51 to the fourth large roll 54, whereby the electrode sheet passing therethrough may be gradually heated, and the fourth large roll 54 and the fifth large roll 55 are brought to have the same final heat treatment temperature, thereby securing a required heat treatment time. For a sequential temperature rise as such, the first large roll 51 may be set at 70° C. to 90° C., the second large roll 52 may be set at 105° C. to 125° C., the third large roll 53 may be set at 120° C. to 140° C., and the fourth and fifth large rolls 54 and 55 may be set at 140° C. to 160° C. When the small rolls 41, 42, 43, and 44 are also provided with the heating means, the first small roll 41 is set to have a temperature between a temperature of the first large roll 51 and a temperature of the second large roll 52, the second large roll 42 is set to have a temperature between the temperature of the second large roll 52 and a temperature of the third large roll 53, the third small roll 43 is set to have a temperature between the temperature of the third large roll 53 and a temperature of the fourth large roll 54, and the fourth small roll 44 is set to have a temperature between the temperature of the fourth large roll 54 and a temperature of the fifth large roll 55 or a temperature identical to temperatures of the rolls.

While the preferred exemplary embodiments of the present invention have been described in detail, the right scope of the present invention is not limited to the disclosed exemplary embodiments, and various variants and modified forms of a person skilled in the art using a basic concept of the present invention as defined in the appended claims also belong to the right scope of the present invention.

### <Description of Symbols>

10: Process unit

20: Rewinding unit

30: Guide roll system

31, 32, 33, 34, 35: Roll

41, 42, 43, 44: Small roll

51, 52, 53, 54, 55: Large roll

1. A guide roll system for transferring an electrode sheet, comprising:
a plurality of rolls disposed in parallel with each other; and
roll heating devices configured to independently heat at least two of the plurality of rolls,
wherein a position of at least one of the plurality of rolls is movable relative to at least one other roll of the plurality of rolls.

2. The guide roll system of claim 1, wherein:
the plurality of rolls includes a first roll, a second roll, and a third roll in an order in which the rolls are disposed, and temperatures of the first roll, the second roll, and the third roll are sequentially high.

3. The guide roll system of claim 2, further comprising:
a fourth roll and a fifth roll which are sequentially disposed next to the third roll, wherein a temperature of the fourth roll is higher than a temperature of the third roll, and a temperature of the fifth roll is identical to or higher than the temperature of the fourth roll.

4. The guide roll system of claim 3, wherein:
the electrode sheet is transferred through lower surfaces of the first roll, the third roll, and the fifth roll and upper surfaces of the second roll and the fourth roll.

5. The guide roll system of claim 4, wherein:
positions of the first roll, the third roll, and the fifth roll are fixed, and the second roll and the fourth roll are configured to be moved up and down.

6. The guide roll system of claim 3, wherein:
the temperature of the first roll is from 70° C. to 90° C., the temperature of the second roll is from 105° C. to 125° C., the temperature of the third roll is from 120° C. to 140° C., and the temperatures of the fourth roll and the fifth roll are from 140° C. to 160° C.

7. The guide roll system of claim 6, wherein:
the temperature of the first roll is 80° C., the temperature of the second roll is 115° C., the temperature of the third roll is 130° C., and the temperatures of the fourth roll and the fifth roll are 150° C., and
a moving speed of the electrode sheet is 40 m/min, and tension applied to the electrode sheet is 80 N.

8. The guide roll system of claim 1, wherein:
the plurality of rolls includes:
a plurality of first type rolls; and
a plurality of second type rolls having a diameter smaller than a diameter of the first type rolls, wherein the roll heating devices are configured to independently heat the plurality of first type rolls.

9. The guide roll system of claim 8, wherein:
positions of the plurality of first type rolls are fixed, and a position of the second type roll is movable in an up and down direction.

10. The guide roll system of claim 8, wherein:
temperatures of the plurality of first type rolls are sequentially high, in an order in which the rolls are disposed.

11. An electrode sheet rolling apparatus, comprising:
a process unit configured to perform a rolling or notching process of an electrode sheet;
a rewinding unit configured to wind the electrode sheet finished with the rolling or notching process in the process unit; and
a guide roll system disposed between the process unit and the rewinding unit, configured to guide the electrode sheet from the process unit to the rewinding unit,
wherein the guide roll system includes a plurality of rolls arranged in parallel with each other and at least one roll of the plurality of rolls has different temperatures from each other.

12. The electrode sheet rolling apparatus of claim 11, wherein:
the plurality of rolls includes a first roll, a second roll, and a third roll in which the rolls are disposed in sequential order, and temperatures of the first roll, the second roll, and the third roll are sequentially high.

13. The electrode sheet rolling apparatus of claim 12, further comprising:
a fourth roll and a fifth roll which are sequentially disposed next to the third roll, wherein a temperature of the fourth roll is higher than a temperature of the third roll, and a temperature of the fifth roll is identical to or higher than the temperature of the fourth roll.

14. The electrode sheet rolling apparatus of claim 13, wherein:
the electrode sheet is transferred through lower surfaces of the first roll, the third roll, and the fifth roll and upper surfaces of the second roll and the fourth roll,
wherein positions of the first roll, the third roll, and the fifth roll are fixed, and the second roll and the fourth roll are configured to be moved up and down.

15. The electrode sheet rolling apparatus of claim 13, wherein:
The temperature of the first roll is from 70° C. to 90° C., the temperature of the second roll is from 105° C. to 125° C., the temperature of the third roll is from 120° C. to 140° C., and the temperatures of the fourth roll and the fifth roll are from 140° C. to 160° C.

16. The electrode sheet rolling apparatus of claim 11, wherein:
the plurality of rolls includes:
a plurality of first type rolls; and
a plurality of second type rolls having a diameter smaller than a diameter of the first type rolls, wherein the roll heating devices are configured to independently heat the plurality of first type rolls.

17. The electrode sheet rolling apparatus of claim 16, wherein:
positions of the plurality of first type rolls are fixed, and a position of the second type roll is movable in an up and down direction.

18. The electrode sheet rolling apparatus of claim 17, wherein:
temperatures of the plurality of first type rolls are sequentially high, in an order in which the rolls are disposed.

19. A method of winding an electrode sheet comprising:
subjecting the electrode sheet to a predetermined process;
passing the electrode sheet through a guide roll system including a plurality of rolls to wind the electrode sheet;
setting a transferring speed of the electrode sheet;
setting temperatures of the plurality of rolls sequentially high along a movement direction of the electrode sheet; and
moving a position of at least a part of the plurality of rolls to adjust tension applied to the electrode sheet.

20. The method of winding an electrode sheet of claim 19, wherein:
the guide roll system includes first to fifth rolls which are sequentially disposed in parallel with each other,
wherein the first roll is set at 70° C. to 90° C., the second roll is set at 105° C. to 125° C., the third roll is set at 120° C. to 140° C., and the fourth roll and the fifth roll are set at 140° C. to 160° C., and
a moving speed of the electrode sheet is set at 20 m/min to 60 m/min, and tension applied to the electrode sheet is 80 N to 120 N.
